(19) United States
(12) Patent Application Publication
(10) Pub. No.: US 2007/0012679 A1
(43) Pub. Date: Jan. 18, 2007

(54) PRINTER TO RADIATE FAR-INFRARED RAYS

(76) Inventors: Deuck-woo Jang, Seongnam-si (KR); Hae-ree Joo, Seoul (KR); Min-young Cheong, Seoul (KR)

Correspondence Address: STANZIONE & KIM, LLP, 919 18TH STREET, N.W., SUITE 440, WASHINGTON, DC, 20006, US

(21) Appl. No.: 11/277,633

(22) Filed: Mar. 28, 2006

(30) Foreign Application Priority Data
Jul. 14, 2005 (KR) 2005-63771

(51) Int. Cl. F27B 5/14; F27D 11/00

(52) U.S. Cl. 219/390

(57) ABSTRACT

A well-being printer to radiate far-infrared rays, the printer including a printer frame, and part or an entire area of the printer frame contains far-infrared ray radiating material. The far-infrared ray radiating material may be active carbon, and the active carbon may be either contained in or coated on the printer frame. An amount of the active carbon may be less than about 5% by weight based on 100% by weight of a plastic of the frame.

### CROSS-REFERENCE TO RELATED APPLICATIONS

This application claims benefit under 35 U.S.C. § 119(a) of Korean Patent Application No. 2005-63771, filed Jul. 14, 2005, the entire contents of which are incorporated herein by reference.

### BACKGROUND OF THE INVENTION

1. Field of the Invention

The present general inventive concept relates to a printer. More particularly, the present general inventive concept relates to a well-being printer to radiate far-infrared rays, which are beneficial to a human body.

2. Description of the Related Art

In using various electronic devices, although there are benefits, there are usually considerable adverse side effects resulting from such use. For example, when a conventional image display apparatus or various communication devices, such as mobile phones and the like, are used by a user, various electromagnetic waves negatively-affect a human body of the user.

To solve these problems of the negative effects of the electromagnetic waves, a technique of radiating far-infrared rays has been developed (See Korean Patent No. 88006 and laid-open Korean Patent No. 98-38057), wherein at least some parts of constituents of the conventional image display apparatus or communication devices are mounted with far-infrared ray radiating materials.

In Korean Patent No. 88006, an external cabinet of an image display apparatus is added and coated with a far-infrared ray radiating material, such as ceramic, in a ratio of 1 to 30 weight %.

According to laid-open Korean Patent No. 98-38057, at least some parts of composing elements comprising a key input unit, a case part, and a body in communication devices (such landline telephones, mobile phones, wireless pagers, facsimile machines, video phones, and walkie talkies) are coated with or made to contain far infra-red ray radiating materials.

With the adaptation of these conventional techniques, harmfulness of the electromagnetic waves radiating from many of the electronic devices has been removed to some extent.

However, due to recent attention to a beneficial effect of far-infrared rays on a well-being of a human body, demands have been increasing for electronic devices manufactured in environment-friendly ways that solve problems inherent in the electronic devices.

For example, regarding printers, because various data and image information is printed in a few seconds on recording media and provided as printed matters, the printers are essential parts of our daily lives. However, there is a problem in that printers discharge environmentally harmful materials, which are noxious and pollute indoor spaces.

As illustrated in FIG. 1, a conventional printer 1 having a frame 2 heats toner to a temperature exceeding 180 degrees Celsius during a fixing process of the printing, discharging harmful components to inside spaces, and due to a heating of a fixer 3, the printer itself is heated, giving rise to a bad feeling in a user.

### SUMMARY OF THE INVENTION

The present general inventive concept solves at least the above problems and/or disadvantages, and provides at least the advantages described below, by providing an environment-friendly well-being printer adapted to allow, for example, a frame of a printer to contain far-infra red ray radiating material so that far infra-red rays can be emitted therefrom to the benefit of a human body.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a printer to radiate far-infrared ray, the printer including a frame having a plurality of parts, at least one of the plurality of parts containing far-infrared ray radiating material.

The frame may be manufactured with at least one plastic of ABS resin, vinyl chloride based resin, and acrylic resin.

The far-infrared ray radiating material may be ceramic or active carbon.

The active carbon may be mixed in an amount less than about 5% by weight based on 100% by weight of the plastic of the frame.

The amount of the active carbon may be in a range of about 0.5% to about 3.5% by weight based on 100% by weight of the plastic of the frame.

The foregoing and/or other aspects and utilities of the present general inventive concept may also be achieved by providing a printer to radiate far-infrared rays, the printer including a frame having a plurality of parts, at least one of the plurality of parts being coated with a far-infrared ray radiating material.

The foregoing and/or other aspects and utilities of the present general inventive concept may also be achieved by providing an image forming apparatus including a frame having a top portion, a bottom portion, a front portion, a back portion, and a side portion, at least one of the portions including a far-infrared radiating material. The far-infrared radiating material may be located in a plurality of portions of the frame. The far-infrared radiating material may be located only in the top portion of the frame. The far-infrared radiating material may be located only in the bottom portion of the frame. The far-infrared radiating material may be located only in the front portion of the frame. The far-infrared radiating material may be located only in the back portion of the frame. The far-infrared radiating material may be located only in the side portion of the frame. The frame may include at least one door, and the far-infrared radiating material may be located only in the at least one door. The frame may include at least one drawer, and the far-infrared radiating material may be located only in the at least one drawer. The frame may include at least one tray, and the far-infrared radiating material may be located only in the at least one tray.

The foregoing and/or other aspects and utilities of the present general inventive concept may also be achieved by providing a printer frame including at least one resin selected from ABS resin, vinyl chloride based resin, and acrylic resin, and at least one far-infrared ray radiating material selected from an active carbon, a alumino-silicate (Al₂O₃—SiO₂) based ceramic, a cordierite (MgO—Al₂O₃—SiO₂) based ceramic, a zircon (ZrO₂—SiO₂) based ceramic, a carbon based ceramic, a yellow soil, and a stone. The printer frame may further include at least one radiation enhancing compound selected from Fe₂O₃ and MnO₂. The printer frame may further include at least one metal compound selected from CuO, Co₃O₄, NiO, Cr₂O₃, TiO₂, B₂O₃, Na₂O, K₂O, Mo₂O₃, and CaO. The at least one far-infrared ray radiating material may be mixed with the at least one resin prior to molding of the frame. The at least one far-infrared ray radiating material may be substantially-evenly distributed throughout the frame. The at least one far-infrared ray radiating material may be located only within the frame, and not located on the surface of the frame. The at least one far-infrared ray radiating material may located within the frame and on the surface of the frame. An amount of the at least one far-infrared ray radiating material in the frame may be less than about 1% by weight based on 100% by weight of the at least one resin. An amount of the at least one far-infrared ray radiating material in the frame may be in a range of about 0.5% to about 3.5% by weight based on 100% by weight of the at least one resin. The at least one far-infrared ray radiating material may be applied as a coating to at least one of an internal surface and an external surface of the frame after molding of the frame. The at least one far-infrared ray radiating material may be located in a separate structure and the separate structure may be attached to the frame of the printer after molding of the printer.

The foregoing and/or other aspects and utilities of the present general inventive concept may also be achieved by providing a method of making an image forming apparatus frame including mixing at least one resin selected from ABS resin, vinyl chloride based resin, and acrylic resin with at least one far-infrared ray radiating material selected from an active carbon, a alumino-silicate (Al₂O₃—SiO₂) based ceramic, a cordierite (MgO—Al₂O₃—SiO₂) based ceramic, a zircon (ZrO₂—SiO₂) based ceramic, a carbon based ceramic, a yellow soil, and a stone, and molding the mixture to form the image forming apparatus frame.

The foregoing and/or other aspects and utilities of the present general inventive concept may also be achieved by providing a method of making an image forming apparatus frame including molding at least one resin selected from ABS resin, vinyl chloride based resin, and acrylic resin to form a molded frame, and coating the molded frame with at least one far-infrared ray radiating material selected from an active carbon, a alumino-silicate (Al₂O₃—SiO₂) based ceramic, a cordierite (MgO—Al₂O₃—SiO₂) based ceramic, a zircon (ZrO₂—SiO₂) based ceramic, a carbon based ceramic, a yellow soil, and a stone to form the image forming apparatus frame.

The foregoing and/or other aspects and utilities of the present general inventive concept may also be achieved by providing a method of forming an image using a printer, the printer including a frame including at least one resin selected from ABS resin, vinyl chloride based resin, and acrylic resin and at least one far-infrared ray radiating material selected from an active carbon, a alumino-silicate (Al₂O₃—SiO₂) based ceramic, a cordierite (MgO—Al₂O₃—SiO₂) based ceramic, a zircon (ZrO₂—SiO₂) based ceramic, a carbon based ceramic, a yellow soil, and a stone, the method including printing an input image using the printer, and radiating far-infrared rays from the frame.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a printer according to the prior art.

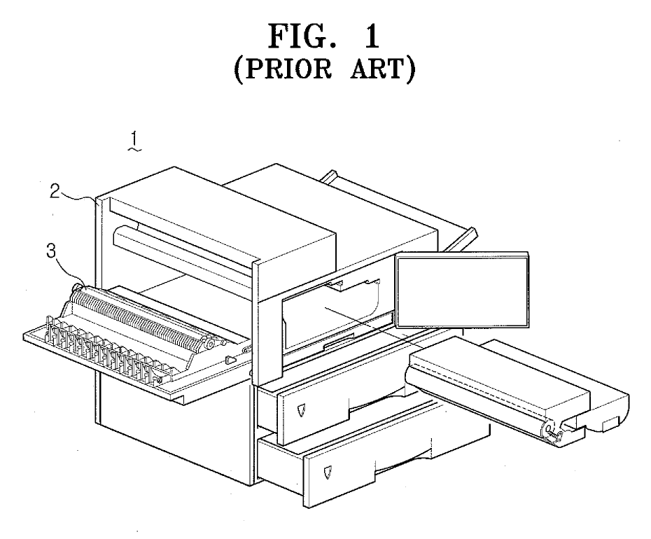

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A frame of a printer according to an embodiment of the present general inventive concept may include a fixer therein and may form an external appearance of the printer. The frame may be manufactured via injection molding with plastic material.

The frame may be made of a frame material, such as plastic. The plastic may be a raw material resin, such as one or more of ABS resin, vinyl chloride based resin, and acrylic resin. In embodiments, the frame of the printer is manufactured with the ABS resin.

The ABS resin is a type of plastic made of three components: styrene, acrylonitrile, and butadiene. The ABS resin is excellent in shock-resistance and heat-resistance, being heat-resistant up to 93 degrees Celsius.

The plastic may also contain one or more of a pigment, a surface active agent, a stabilizer, a plasticizer, and a filler.

The printer to radiate far-infrared ray according to an embodiment of the present general inventive concept may be manufactured in such a manner that all or part of the frame contains (e.g., is injection-molded with) far-infrared ray radiating material. For example, the far-infrared ray radiating material may be mixed with all of the material components of the frame before the frame is molded, and allowed to move to any or all locations on the frame. Alternatively, the far-infrared radiating material may be controlled so as to be located only at specific portions of the frame. For example, if the frame includes a door that can be opened to insert a printer cartridge, the far-infrared radiating material may be controlled so as to be located only at the door, or at portions of the frame except for the door. Moreover, the far-infrared radiating material may be controlled so as to be located only on the surface of the frame, only within the frame (i.e., not on the surface of the frame), or both on the surface of the frame and within the frame.

Far-infrared rays are electromagnetic waves having a wavelength in a range of about 4 to about 1000 μm, and are indirectly generated from solar radiant heat and heating equipment.

The far-infrared rays affect a human body in two ways: in the forms of a thermal effect and a non-thermal effect.

The thermal effect can affect peripheral tissues and can even affect an entire living body. Specifically, thermal energy is absorbed by skin from the far-infrared rays and is transported by way of blood flowing in peripheral blood vessels to the peripheral tissues and even to the entire living body.

On the other hand, the non-thermal effect penetrates an outer skin surface. Specifically, photons corresponding to a particular wavelength of far-infrared rays penetrate to receptors on membranes of inner skin cells. Thus, the far-infrared rays are transmitted into cells through receptors of inner skin cell membranes, resulting in activation of the cells. In embodiments, the far-infrared rays can penetrate through the skin up to a distance of about 4 cm. For example, to about the far-infrared rays can penetrate through the skin to a distance of about 100 μm to about 4 cm.

Thus, the far-infrared ray is a thermal energy-providing source in the thermal effect and a photon-providing source in the non-thermal effect.

The direct thermal effect of the far-infrared rays thus serve to promote blood circulation in the human body and to quickly discharge body wastes. On the other hand, the indirect non-thermal effect of the far-infrared rays is caused by activation of water in the human body and by the non-thermal effect stimulating receptors of nerves detecting various senses located, for example, near 100 μm in the skin of the human body.

As a result, the far-infrared ray is beneficial in assisting the circulation of substances, such as through blood vessels in the human body, by emitting a strong power warming the substances and expanding capillary vessels of the human body.

Although far-infrared rays are radiated from all substances on earth to some extent a far-infrared ray radiation rate is particularly high in active carbons, yellow soils, stones and ceramics.

Such ceramics include, but are not limited to, alumino-silicate (Al₂O₃—SiO₂) based ceramics, cordierite (MgO—Al₂O₃—SiO₂) based ceramics, zircon (ZrO₂—SiO₂) based ceramics, and carbon based ceramics.

Furthermore, Fe2O3 and MnO2 may be mixed with the far-infrared radiating material (e.g., with the ceramics and/or the active carbon) to enhance a radiating efficiency and/or the radiation rate. In addition, metal compounds, such as CuO, Co₃O₄, NiO, Cr₂O₃, TiO₂, B₂O₃, Na₂O, K₂O, Mo₂O₃, and CaO may be mixed with the far-infrared radiating material.

The printer according to an embodiment of the present general inventive concept may include the active carbon as the far-infrared ray radiating material, which may be contained in the frame of the printer. The far-infrared rays emitted from the active carbon have a very high radiation rate. Particularly, the active carbon has an excellent radiation rate at room temperature as well as at high temperatures, such as temperatures at which a fixer is heated. Furthermore, the active carbon is excellent in absorption. Moreover, because many materials used to make the frame are made of carbon, using active carbon for the far-infrared rays results in an increase in the strength of the frame.

In embodiments, an amount of the active carbon in the frame is less than about 5% by weight based on 100% by weight of the plastic material of the frame. For example, the amount of the active carbon in the frame may be less than about 1% by weight based on 100% by weight of the plastic material of the frame. Furthermore, the amount of the active carbon may be in a range of about 0.5% to about 3.5% by weight based on 100% by weight of the plastic of the frame. If the amount of the active carbon contained in the plastic is too large, there is a difficulty in forming the frame, and alternatively, if the content is too small, there is a lack of discharge effect of far-infrared rays.

Although the present general inventive concept has been described above as a mixture of the far-infrared radiating material with plastic to be contained in the frame of the printer, the present general inventive concept is not so limited. For example, it is also possible to prepare the far-infrared ray radiating material as a paste and to coat the paste on an inside and/or on an outside of the printer frame. In addition, the far-infrared radiating material may be added as an entirely separate entity from the frame, and subsequently attached to the frame to provide the far-infrared rays. For example, the far-infrared radiating material may be added to a decoration, such as a small statuette, which may then be attached to the frame of the printer.

Coating the far-infrared ray radiating material on the frame makes manufacturing a well-being printer easier than when the far-infrared radiating material is contained in the frame, such as by mixing the far-infrared radiating material with other material components of the frame prior to molding the frame. Furthermore, coating the far-infrared ray radiating material on the frame permits partial and/or selective coating on a needed and/or desired area of the frame (as opposed to the entire frame).

Generally, the printer is heated when information is printed on recording media due to heat generated from a fixer of the printer. However, because the printer according to an embodiment of the present general inventive concept contains active carbon as the far-infrared ray radiating material, and because a thermal conductivity of the active carbon is excellent, the temperature of the heated printer can be quickly reduced to room temperature.

As apparent from the foregoing, the printer to radiate far-infrared ray according to an embodiment of the present general inventive concept thus described can radiate far-infrared rays beneficial to the human body, and the user using the printer can be provided with energy and vitality given by the far-infrared rays. In addition, the printer according to an embodiment of the present general inventive concept can be quickly cooled down, and the strength of the printer can be increased to improve a durability of the printer.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printer to radiate far-infrared rays, the printer comprising a frame having a plurality of parts, at least one of the plurality of parts containing far-infrared ray radiating material.

2. The printer as defined in claim 1, wherein the frame is manufactured with at least one plastic of ABS resin, vinyl chloride based resin, and acrylic resin.

3. The printer as defined in claim 2, wherein the far-infrared ray radiating material is active carbon.

4. The printer as defined in claim 3, wherein an amount of the active carbon in the frame is less than about 5% by weight based on 100% by weight of the plastic of the frame.

5. The printer as defined in claim 4, wherein the amount of the active carbon is in a range of about 0.5% to about 3.5% by weight based on 100% by weight of the plastic of the frame.

6. The printer as defined in claim 1, wherein at least one of the plurality of parts is coated with the far-infrared ray radiating material.

7. The printer as defined in claim 6, wherein the frame is manufactured with at least one plastic of ABS resin, vinyl chloride based resin, and acrylic resin.

8. The printer as defined in claim 7, wherein an amount of the active carbon in the frame is less than about 5% by weight based on 100% by weight of the plastic of the frame.

9. The printer as defined in claim 1, wherein the far-infrared ray radiating material is at least one of alumino-silicate based ceramic (Al₂O₃—SiO₂), cordierite based ceramic (MgO—Al₂O₃—SiO₂), zircon based ceramic (ZrO₂—SiO₂), and carbon based ceramic.

10. The printer as defined in claim 9, wherein the far-infrared ray radiating material further comprises at least one metal compound selected from Fe₂O₃, MnO₂, CuO, Co₃O₄, NiO, Cr₂O₃, TiO₂, B₂O₃, Na₂O, K₂O, Mo₂O₃, and CaO.

11. An image forming apparatus, comprising a frame having a top portion, a bottom portion, a front portion, a back portion, and a side portion, at least one of the portions comprising a far-infrared radiating material.

12. The image forming apparatus of claim 11, wherein the far-infrared radiating material is located in a plurality of portions of the frame.

13. The image forming apparatus of claim 11, wherein the far-infrared radiating material is located only in the top portion of the frame.

14. The image forming apparatus of claim 11, wherein the far-infrared radiating material is located only in the bottom portion of the frame.

15. The image forming apparatus of claim 11, wherein the far-infrared radiating material is located only in the front portion of the frame.

16. The image forming apparatus of claim 11, wherein the far-infrared radiating material is located only in the back portion of the frame.

17. The image forming apparatus of claim 11, wherein the far-infrared radiating material is located only in the side portion of the frame.

18. The image forming apparatus of claim 11, wherein the frame comprises at least one door, and the far-infrared radiating material is located only in the at least one door.

19. The image forming apparatus of claim 11, wherein the frame comprises at least one drawer, and the far-infrared radiating material is located only in the at least one drawer.

20. The image forming apparatus of claim 11, wherein the frame comprises at least one tray, and the far-infrared radiating material is located only in the at least one tray.

21. A printer frame, comprising:
at least one resin selected from ABS resin, vinyl chloride based resin, and acrylic resin; and
at least one far-infrared ray radiating material selected from an active carbon, a alumino-silicate (Al₂O₃—SiO₂) based ceramic, a cordierite (MgO—Al₂O₃—SiO₂) based ceramic, a zircon (ZrO₂—SiO₂) based ceramic, a carbon based ceramic, a yellow soil, and a stone.

22. The printer frame according to claim 21, further comprising at least one radiation enhancing compound selected from Fe₂O₃ and MnO₂.

23. The printer according to claim 21, further comprising at least one metal compound selected from CuO, Co₃O₄, NiO, Cr₂O₃, TiO₂, B₂O₃, Na₂O, K₂O, Mo₂O₃, and CaO.

24. The printer frame according to claim 21, wherein the at least one far-infrared ray radiating material is mixed with the at least one resin prior to molding of the frame.

25. The printer frame according to claim 21, wherein the at least one far-infrared ray radiating material is substantially-evenly distributed throughout the frame.

26. The printer frame according to claim 21, wherein the at least one far-infrared ray radiating material is located only within the frame, and is not located on the surface of the frame.

27. The printer frame according to claim 21, wherein the at least one far-infrared ray radiating material is located within the frame and on the surface of the frame.

28. The printer frame according to claim 21, wherein an amount of the at least one far-infrared ray radiating material in the frame is less than about 1% by weight based on 100% by weight of the at least one resin.

29. The printer frame according to claim 21, wherein an amount of the at least one far-infrared ray radiating material in the frame is in a range of about 0.5% to about 3.5% by weight based on 100% by weight of the at least one resin.

30. The printer frame according to claim 21, wherein the at least one far-infrared ray radiating material is applied as a coating to at least one of an internal surface and an external surface of the frame after molding of the frame.

31. The printer frame according to claim 21, wherein the at least one far-infrared ray radiating material is located in a separate structure and the separate structure is attached to the frame of the printer after molding of the printer.

32. A method of making an image forming apparatus frame, comprising:
mixing at least one resin selected from ABS resin, vinyl chloride based resin, and acrylic resin with at least one far-infrared ray radiating material selected from an active carbon, a alumino-silicate (Al₂O₃—SiO₂) based ceramic, a cordierite (MgO—Al₂O₃—SiO₂) based ceramic, a zircon (ZrO₂—SiO₂) based ceramic, a carbon based ceramic, a yellow soil, and a stone; and
molding the mixture to form the image forming apparatus frame.

33. A method of making an image forming apparatus frame, comprising:
molding at least one resin selected from ABS resin, vinyl chloride based resin, and acrylic resin to form a molded frame; and
coating the molded frame with at least one far-infrared ray radiating material selected from an active carbon, a alumino-silicate (Al₂O₃—SiO₂) based ceramic, a cordierite (MgO—Al₂O₃—SiO₂) based ceramic, a zircon (ZrO₂—SiO₂) based ceramic, a carbon based ceramic, a yellow soil, and a stone to form the image forming apparatus frame.

34. A method of forming an image using a printer, the printer comprising a frame including at least one resin selected from ABS resin, vinyl chloride based resin, and acrylic resin and at least one far-infrared ray radiating material selected from an active carbon, a alumino-silicate (Al₂O₃—SiO₂) based ceramic, a cordierite (MgO—Al₂O₃—SiO₂) based ceramic, a zircon (ZrO₂—SiO₂) based ceramic, a carbon based ceramic, a yellow soil, and a stone, the method comprising:
printing an input image using the printer; and
radiating far-infrared rays from the frame.
